(19) United States
(12) Patent Application Publication
(10) Pub. No.: US 2006/0085284 A1
(43) Pub. Date: Apr. 20, 2006

(54) Dedicated communications network for the dissemination of information linked to themed events and a method of promoting business-to-business sales via the communications network

(76) Inventor: Cynthia Hall Cardenas, Coppell, TX (US)

Correspondence Address: VESNA N. RAFATY;ATTORNEY & COUNSELOR, 18926 CAMPBELL ROAD, DALLAS, TX, 75252, US

(21) Appl. No.: 11/253,179

(22) Filed: Oct. 18, 2005

Related U.S. Application Data
(60) Provisional application No. 60/619,732, filed on Oct. 18, 2004.

(51) Int. Cl. H04N 7/16

(52) U.S. Cl. 705/26; 725/5

(57) ABSTRACT

A communications network, such as a radio station, television station, or webcast, dedicated to the continuous dissemination of program content relating to the subject matter of themed events, themed events being live, scheduled events with attendees, the program content comprising segments involving subject matter experts and a program guest, the subject matter experts paying to participate in the program and paying to exhibit at the themed event, wherein subject matter experts sell tickets to the themed event to help recoup their costs of participation in the themed event and the program. A method of funding programs broadcast on a communications network wherein the program is linked to a themed event.

This non-provisional patent application incorporates by reference and claims priority to U.S. Patent Application 60/619,732 which has an effective filing date of Oct. 18, 2004.

### I. TITLE OF THE INVENTION

A dedicated communications network for the dissemination of information linked to themed events and a method of promoting business-to-business sales via the communications network

### II. BACKGROUND OF THE INVENTION

The disclosed invention is directed to a business model for the facilitation and promotion of business-to-business (B2B) sales at themed events. More specifically, the disclosed invention is directed to a communications network, such as but not limited to a radio or television station, dedicated exclusively to the continuous delivery of programming covering subject matter which relates to themes of themed events. The disclosed invention is also directed to a method of funding a radio program whereby payment for participation in a themed event linked to the radio program funds the radio program.

B2B sales via the venue of themed events (herein called “Themed Events” and defined below) such as trade shows are known. Thousands of Themed Events are held each year and the number of possible new themes is growing and is limited only by the creativity of the organizers and sponsors of such events and market needs. During a Themed Event, exhibitors (also “Event Stakeholders” or subject matter experts (SME's) as defined below) seek to introduce event attendees to the exhibitors' products and services. Event Stakeholders also make offers for sale and execute sale transactions with event attendees during the Themed Events.

The term “Themed Event” as used in this specification refers broadly to any scheduled live event, whether one-time or recurring (periodic), such as but not limited to a conference, trade show, convention, exposition, forum, fair, or seminar, organized, promoted, and hosted by an entity called herein an “Event Organizer,” in which the event participants, herein called “Event Stakeholders,” are invited, selected, or admitted to participate based on some association or group membership criteria or the relevance of their products or services to the theme, i.e., the purpose or common subject matter, of the Themed Event. The theme or common subject matter or common purpose behind the Themed Event shall be broadly interpreted herein and shall encompass various industry groups and market segments. The term “Event Stakeholder” as used in this specification refers to individuals who, in return for the payment of a fee to the Event Organizer, have the right to participate in, display, exhibit and/or sell their products and services at a themed event conducted by the Event Organizer. The term “subject matter expert” (SME) as used herein refers broadly to Event Stakeholders and/or authorized representatives and/or agents of Event Stakeholders who possess expert knowledge about products, services, and/or the industry of the Event Stakeholders. Note that the terms Event Stakeholders, SME's, and Event Stakeholders/SME's are used interchangeably. When describing the preferred embodiment of the disclosed invention directed to B2B sales targeting entrepreneurs and start-up businesses, SME shall refer to individuals or entities who possess expertise or knowledge in one or more areas (e.g., financing, advertising, marketing, operations, quality control, domestic and foreign sales, governmental regulation, insurance, legal issues) of particular interest to entrepreneurs, wannabe entrepreneurs, or other individuals who are interested in starting up, operating, or managing a small business entity. The term “Attendee” as used herein is a visitor to a Themed Event who is a non-Event Stakeholder, non-SME.

There is currently no communications network which is dedicated to continuously providing content aimed at maximizing outreach to potential Attendees of Themed Events and Event Stakeholders/SME's. Themed Events are typically announced on television, radio, webcasts on the Internet, newspapers, and web sites. The advertisements answer the five W's about the event, namely the what, when, where, who, and why, but rarely give the prospective attendee an in-depth look at the information and the educational opportunities of the event.

While the use of radio, television, and the Internet to announce upcoming themed events is not novel, while there are radio shows which sponsor conferences (e.g., KRLD talk show which supplements and supports an annual event called “Building Your Business”), and while there are webcasts (e.g., Startup Nation Radio) which provide themed programs in an interactive format, there is currently no communications network, such as a radio station, a webcast, or a television program or television channel, which, for twenty-four hours every day continuously informs listeners and/or viewers, as the case may be, via an in-depth, interactive, consistent program format involving SME's about themed events and the products and services which relate to the theme of each such events.

Additionally, there is currently no communications network, such as a radio station or a television station, dedicated to in-depth coverage of themed events as they occur. Traditionally, coverage of themed events such as conventions and trade shows while the events are ongoing is limited to brief commentaries aired on radio or television whereby a reporter on-site at the event summarizes his/her observations about the event and pauses to interview at random an attendee or an event stakeholder. The lack of focused, in-depth coverage of themed events as they occur creates a significant gap in promotion possibilities for such events.

Typically, there are at least two major categories of out-of-pocket costs borne by Event Stakeholders at themed events: the cost of participation, which includes a booth or venue fee, and the cost of advertising (if any) to a target audience their participation in the themed event. Advertising costs for themed events are typically borne by event sponsors who are often the big name event participants, the large, highly capitalized businesses. The smaller event stakeholders typically don't have the funds to support an independent ad campaign highlighting their products and services and their involvement in the themed event. Thus, because the smaller stakeholders don't have the capital to fund an aggressive pre-event promotion campaign, the smaller stakeholders are currently not maximizing the benefit derivable from their participation in themed events.

Radio stations rely on advertising revenues from advertisers who purchase radio airtime in minute and half-minute increments. But, radio stations today are losing money because of a decline in their advertising revenues. Radio listeners tune out radio commercials and so advertisers on radio are being more cautious with their advertising budgets. What is needed is a novel way to fund a radio station which is not dependent upon advertising dollars from traditional advertisers.

What is needed is a novel way to link Event Organizers and Event Stakeholders/SME's in a common goal of promoting initial attendance and repeat attendance at Themed Events.

What is needed is a dedicated communications network which provides listeners/viewers in-depth information about the subject matter of Themed Events before such events occur, as they occur, and after they occur. The dedicated communications network will build a loyal listening and viewing segment of the population and has the potential to increase attendance at the themed events.

### III. SUMMARY OF THE INVENTION

The disclosed invention is generally directed to facilitation and promotion of B2B sales (and sales in general) via themed events, and is also directed to a method of funding programs intended to be broadcast to the public by linking the programs to themed events. The disclosed business model comprises the following combination of elements: themed events/themed event organizers, a communications network dedicated exclusively to delivering segments of programming relating to themed events, SME's who pay to participate in Themed Events and program segments covering subject matter on theme(s) of the Themed Events, and program guests who are target attendees of the Themed Event. Per the preferred embodiment of the disclosed invention for Themed Events targeting entrepreneurs, start-up businesses, and small businesses, SME's, desirous of growing their business and doing outreach to target clients, pay to participate in a specially-produced radio program, pay to exhibit at a themed event that is linked by theme to the radio program, have the opportunity to sell tickets to the Themed Event to help recoup SME's costs of participation, and may also commit to conduct seminars at the themed event. Each program segment may have a predictable and consistent format comprising a 30-minute or one-hour long moderated roundtable discussion where a pre-screened guest, the problem owner, a small business owner or wannabe entrepreneur, who, having won the right to be in the radio program, receives free advice and insight into his pre-defined real-life problem. The radio program may be described as “reality radio for small business in a cooperative model.” The taped radio program may be broadcast repeatedly over the communication network. SME's who participate in the radio program may be authorized to post the program or segments of the program on the SME's web site thereby promoting the SME's services as well as the themed event that is linked to the program. The disclosed model is a cooperative model because via the radio program the SME's generously give free advice to the guest entrepreneur and the listening audience. In return, the SME is actively and effectively promoting his/her business to a target client base that is engaged in part because of incentives which include but are not limited to the prospect of receiving free business advice via the program, and drawings and other give-aways to earn the right to be a guest on the radio program for free or to attend the themed event for free. The mix of SME's on any given program may vary and is adapted to include SME's who have the knowledge and expertise dictated by the real-life problem presented by the program guest.

An alternative embodiment comprises a television program, taped or live, wherein the format is similar to the radio program, namely a one-hour or thirty-minute segment of moderated roundtable discussion involving SME's and a guest.

Per one optional feature of the disclosed invention, Event Organizers offer Event Stakeholders/SME's an opportunity to sell a number of tickets to a Themed Event and the receipts from the ticket sales help recoup some or all of the Event Stakeholder's/SME's participation fee in the Themed Event and the program. Thus, per the disclosed feature, the out-of-pocket costs incurred by Event Stakeholders/SME's for their participation in the Themed Event and for advertising of their business are minimized or even potentially eliminated. Also, per this feature of the disclosed invention, the disclosed communications network does not rely on traditional advertisers for advertising revenues.

To help promote ticket sales, Event Organizers may offer prizes, giveaways, or types of incentives to listeners/viewers of the dedicated communications network. Also as part of the disclosed model, Event Organizers may organize special events (e.g., dinners, networking meetings, contests or fund-raisers) to take place between the dates of the Themed Events in which to do outreach to prospective attendees as well as prospective Event Stakeholders.

Per an optional feature of the disclosed model wherein Event Stakeholders sell tickets to prospective Attendees, Event Stakeholders are required to collect and then share with Event Organizers demographic and other identifying information about individuals who purchase tickets to themed events from Event Stakeholders/SME's. Event Organizers then compile the information in a database of leads, herein referred to as the Themed Event Attendees Database, for use in marketing future Themed Events.

The preferred embodiment of the disclosed invention is a communication network whose target audience includes individuals who are entrepreneurs or entrepreneur wannabes and existing businesses that would benefit from advice and counsel delivered by “subject matter experts” in areas relating to the various aspects (e.g., business formation, raising capital, financial management, human resources management, organizational knowledge management, marketing, sales, manufacturing, quality, risk management, legal matters) of running a business.

Per a preferred embodiment, the communications network is a radio station, either satellite or traditional, which airs, then repeats, six consecutive shows per day, each show being two hours in duration and comprising four thirty-minute segments. The shows may be archived and available for access by visitors to a website operated by the Event Organizer, SME, or the communications network.

It will be obvious that other program formats for the dedicated communications network are possible and such alternative program formats are considered to be within the scope of the disclosed invention. A novel aspect of the disclosed invention is the provision for a communications network which is dedicated exclusively to continuous broadcasting of program content linked to Themed Events.

It will be obvious that the dedicated communications network per the disclosed invention may be a network in the television, cable television, Internet medium, and/or any other broadcast medium that becomes known in the future.

In the preferred embodiment of the disclosed business model, the dedicated communications network, such as a radio station, is owned and operated by the entity that organizes and hosts the themed recurring event. However, to practice the disclosed invention, it is not necessary that the communications network be owned and operated by the Event Organizer entity.

For the radio listener, web audience, and the television viewer, the disclosed communication network creates an efficient one-stop shop or reference for in-depth, interactive coverage of subject matter relating to themed recurring events, whether or not that radio listener, web audience, or television viewer chooses to attend the themed events. Such a forum is unique and does not exist today. For example, individuals interested in finding out about upcoming themed events typically consult their local print media such as event guides printed in local newspapers which merely announce local happenings, rarely offer in-depth coverage, and never offer an interactive educational experience relating to such themed events.

Another feature of the disclosed invention is that it facilitates the creation of a proprietary database, herein referred to as the Attendee Database, containing demographics and other identifying information on Attendees. Such a database represents valuable business leads for SME's and also helps Event Organizers attract SME's to Themed Events as well as better market Themed Events to prospective attendees. Event Organizers and event stakeholders will be able to use the information from the Attendee Database to create new themed events and to develop targeted outreach programs and new program formats for the disclosed communications network. Through these types of efforts, a grass roots community of like-minded individuals is formed.

The disclosed communications network has the added benefit of creating over time a new a growing pool of widely-recognized SME's. Thanks to the program format of the dedicated communications network per the preferred embodiment, which relies on SME's, subject matter experts who appear and reappear on the programs will become familiar to listeners/viewers and will grow in acceptance and credibility, much like the highly paid celebrity subject matter experts who benefit from constant media attention.

Another benefit of the disclosed invention is its potential to build and promote a sense of community within and among segments of the population, represented by the listeners, callers, and viewers of the disclosed communications network, all of whom turn to the communications network to be informed and to share their interests in some common theme or subject matter. The disclosed invention may also build and promote the local community and its economy by promoting an increase in the number of themed recurring events organized. So, for example, the disclosed invention may be used to create and conduct themed events such as Everything Entrepreneur™ and The Love Coach. At Everything Entrepreneur™, owners of start-up businesses go to get focused assistance with establishing and growing their businesses. Thus, investors, financial planners, business trainers, and business consultants are likely event stakeholders at such an event. At a themed event called The Love Coach, attendees seek and receive assistance and counsel from professionals with their personal relationships, business relationships, health, fitness, and wellness.

### IV. BRIEF DESCRIPTION OF THE DRAWINGS

FIG. 1 is an entity-relationship drawing showing the major entities per the preferred embodiment of the disclosed system for promotion and funding of B2B sales via themed events.

FIG. 2 is a block diagram showing major steps in the disclosed method of funding a radio program via linkage to a themed event

### V. DESCRIPTION OF THE DRAWINGS

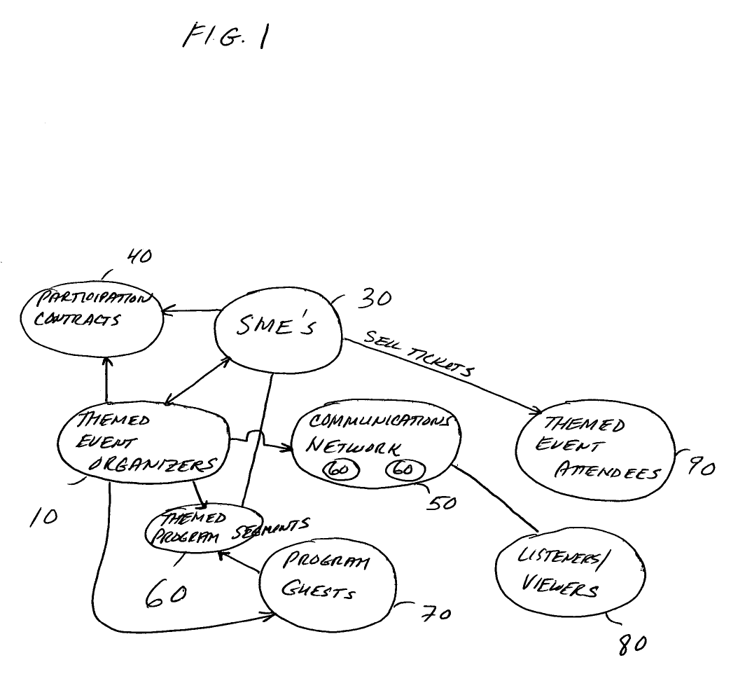

FIG. 1 is an entity-relationship drawing showing the major entities per the preferred embodiment of the disclosed system for promotion and funding of themed events. Note that the use of a singular form or plural form of nouns herein shall be construed to refer to both the plural and singular form. The major entities are Themed Event Organizers 10, Themed Events 20, Themed Event Stakeholders/SME's 30, Participation Contracts 40 between Themed Event Organizer 10 and Themed Event Stakeholder/SME's 30, Communications Network 50 comprising Themed Program Segments 60, Themed Program Guest 70, Themed Program Segment Listeners/Viewers 80, Themed Event Attendees 90. Per the disclosed system, Themed Event Organizers 10 develop, schedule, and conduct Themed Events 20 based on data such as but not limited to market research data. Themed Event Organizers 10 either own and operate or purchase program time on a Communications Network 40 which is dedicated exclusively to delivery of program content disseminating information linked to themes relating to Themed Events. Themed Event Organizers 10 solicit and secure Participation Contracts with Themed Event Stakeholders/SME's 20. Themed Event Stakeholders/SME's 10 solicit and sell tickets to Themed Events to Themed Event Attendees. From their ticket sales receipts, Event Stakeholders/SME's 20 pay Event Organizers 10 an event participation fee. Event Stakeholders 20 share with Event Organizers 10 demographic and other identifying data about ticket purchasers. Event Organizers 10 produce Themed Event Programs for broadcast on the Communications Network 40 while involve participation of Themed Event Stakeholders/Subject Matter Experts 30 Event Organizers 10 and Event Stakeholders 20 develop programs for the Communications Network 40. The programs disseminate to Listeners/Viewers 50 information linked to themed recurring events before the events occur, during the events, and after the events.

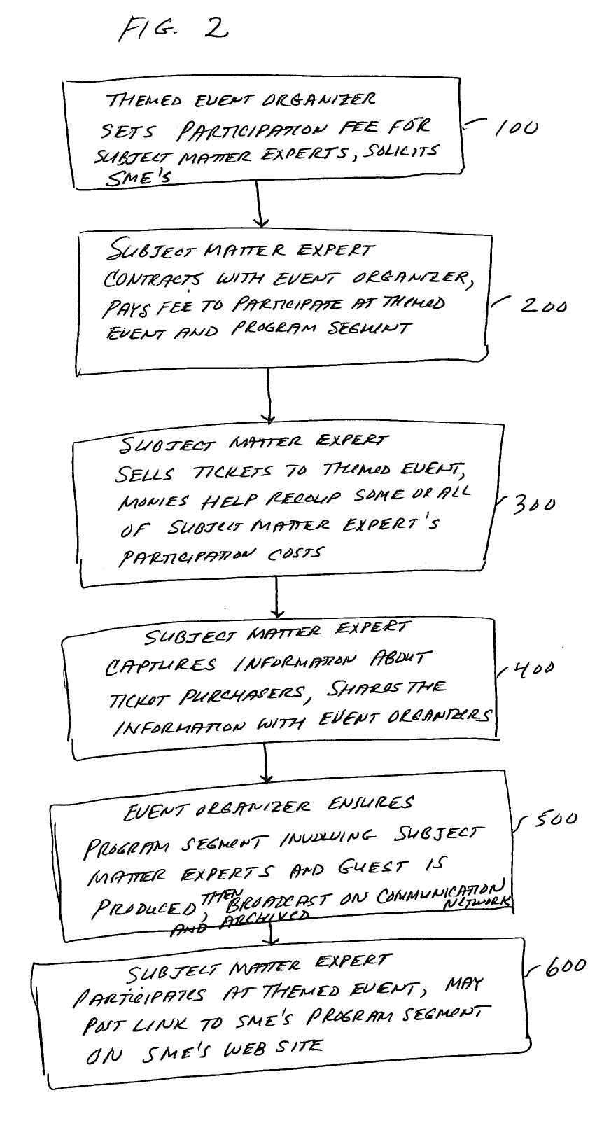

FIG. 2 is a block diagram showing the major steps in the disclosed method for funding a program such as but not limited to a radio program by linkage to a Themed Event. Thus, per FIG. 2, Block 100, Themed Event Organizers, having identified a Themed Event to promote and conduct, determine and set a participation fee, and then solicit Event Stakeholders/SME's for participation in both the Themed Event and a program segment linked to the Themed Event. Per Block 200, Event Stakeholders/SME's enter into participation contacts with Event Organizers. Per Block 300, SME's sell tickets to the themed event, and receipts thereof help recoup some or all of the SME's participation costs. Per Block 400, SME's collect information about ticket purchasers and share that information with Event Organizers, who use the information to build a Themed Event Attendee Database. Per Block 500, Event Organizers oversee the creation of program segment which involves SME's and at least one program guest. The program segment is then broadcast over a communication network, which may or may not be a communication network dedicated to the coverage of themed events. The program segment may be archived for posting on a web site. Per Block 600, SME's participate in the Themed Event. Participation may include, but is not limited to, providing an exhibit or booth or conducting a live seminar.

I claim:

1. A communications network dedicated exclusively to the continuous delivery of programs disseminating information linked to themed events, the themed events being live, scheduled events, the programs comprising segments which utilize a consistent format wherein one or more subject matter experts delivers advice to one or more program guests on real-life problems confronting the program guest, the problem related to a theme of the themed event and of potential interest to attendees of the themed event, wherein the subject matter experts pay to participate at the themed event and the program segment.

2. A communications network of claim 1 wherein the themed event is a trade show which targets attendees comprising individuals who are entrepreneurial and wherein the real-life problem facing the program guest is a business-related problem.

3. A communications network of claim 1 where the communications network is a traditional radio station.

4. A communications network of claim 1 where the communications network is a satellite radio station.

5. A communications network of claim 1 wherein the communications network is a television station.

6. A method for promotion of a themed event, the themed event a live, scheduled event, comprising the steps of:
Soliciting subject matter experts having expertise and knowledge of interest to attendees of the themed event for participation in a program to be broadcast over a communication network, the communications network dedicated exclusively to the continuous delivery of programs disseminating information linked to themed events, the subject matter experts paying to participate in the program and the themed event,
Providing the program, the program involving participation of subject matter experts in a discussion format involving the delivery of advice to a program guest on a real-life problem confronting the program guest and relating to the theme of the themed event.
Broadcasting the program via the communications network.

7. The method per claim 6 wherein the themed event targets attendees who are entrepreneurial and wherein the roundtable discussion format includes the participation of subject matter experts and one program guest who is a small business owner.

8. The method per claim 6 further comprising the following step: Providing a link on a web site enabling a visitor to the web site to access the program after it has been archived after being broadcast.

9. The method per claim 6 wherein subject matter experts sell tickets to the themed event and provide information about ticket purchasers to the entity that organizes the themed event.

10. A method, by a subject matter expert, of promoting his/her business comprising the steps of:
Participating in the making of program content, the program content linked to the theme of a themed event, the themed event a live scheduled event with attendees, wherein the subject matter expert delivers advice to one or more program guests, the program guest(s) interested in receiving advice from the subject matter expert on a real-life problem confronting the program guest(s), and wherein the program content is intended to be broadcast via a communications network dedicated to the continuous delivery of program content linked to themed events,
Participating at the themed event that is linked to the subject matter of the program content, and
Having the opportunity to sell tickets to the themed event to prospective attendees to help recoup some or all of the subject matter expert's participation costs in the program and the themed event.

11. The method of claim 10 further comprising the following step:
Conducting a live seminar at the themed event.

12. Content comprising a program segment broadcast over a communications network dedicated exclusively to the continuous delivery of programs disseminating information linked to themed events, the themed events being live, scheduled events with attendees, the program segment having a format wherein at least one subject matter expert delivers advice to one or more program guests on real-life problems confronting the program guest(s), the problem related to the theme of the themed event and of potential interest to attendees of the themed event.

13. Content per claim 12 wherein the content is a podcast.

14. A method of funding a radio program whereby program participants pay to participate at a themed event and as subject matter experts in the radio program, the radio program treating subject matter related to the theme of the themed event, the themed event a live, scheduled event with attendees.
